(19) United States
(12) Patent Application Publication
(10) Pub. No.: US 2002/0064354 A1
(43) Pub. Date: May 30, 2002

(54) Automatic fiber preparation unit for splicing

(76) Inventors: Scot K. Ware, Brentwood, TN (US); Brett G. Clark, Whites Creek, TN (US); Michael Royce Cripps JR., Murfreesboro, TN (US); David Wayne Sellers, Franklin, TN (US); Jared Cassidy Meitzler, Franklin, TN (US); Jason Thomas Troyer, Brentwood, TN (US)

Correspondence Address: BANNER & WITCOFF, 1001 G STREET N W, SUITE 1100, WASHINGTON, DC, 20001, US

(21) Appl. No.: 09/725,054

(22) Filed: Nov. 29, 2000

(51) Int. Cl. G02B 6/255

(52) U.S. Cl. 385/95; 385/147

(57) ABSTRACT

Apparatuses and methods for automatically preparing optical fibers for splicing by automatically positioning an optical fiber at a stripping station, a cleaning station, and a cleaving station. The processing of the optical fiber at the various stations is also preferably automated. The optical fiber may be held by an optical fiber holder and/or a carriage, which may translate and/or rotate the optical fiber amongst the various stations. Where the optical fiber is translated only along a single axis, the unit may be configured to be quite reliable, compact, and inexpensive to manufacture.

### FIELD OF THE INVENTION

The present invention relates to apparatuses and methods for automatically preparing optical fibers for splicing, and more particularly to an automatic fiber preparation unit that prepares an optical fiber for splicing by automatically positioning an optical fiber at a stripping station, a cleaning station, and a cleaving station, and methods relating thereto.

### BACKGROUND OF THE INVENTION

In the optical fiber industry, splicing of optical fibers is a common practice. To splice two optical fibers together, the following steps are usually performed in the following order: stripping of the protective coating from a portion of the ends of the optical fibers; cleaning of the optical fiber ends, such as through use of an ultrasonic cleaner; cleaving the optical fibers to produce a clean tip suitable for splicing; placing the cleaved optical fiber into a splicer and splicing the optical fiber with another optical fiber; testing the splice; and finally covering the splice with a protective coating. Splicing is a delicate art and requires that the resulting splice meet strict physical requirements so as to limit the amount of light lost that passes through the splice when in use. Successful splicing also requires that each step in the process be performed accurately and properly. If an optical fiber is not prepared properly, the quality of the splice will be low regardless of the care taken in the splicing step.

Individual machines exist for performing various splicing and splicing-related operations on an optical fiber. However, these machines are often quite large and heavy. Also, the fiber preparation stage is manually intensive normally requiring human interaction to move the fibers from machine to machine to prepare the fibers for splicing. This human interaction can be time consuming and result in high labor costs. Additionally, operator handling of the optical fibers between stages increases the risk of scratching and contaminating the fibers before splicing. This may lead to unsatisfactory splices that reduce the performance of the splices or require the splices to be discarded. Any attempts to overcome these drawbacks have not been commercially viable.

### SUMMARY OF THE INVENTION

There is a need for a simpler and commercially feasible device that prepares optical fibers for splicing. Such a device should preferably be compact and reliable. Such a device should further preferably provide a high throughput and minimize human intervention so as to lower the time and labor costs required in preparation of the optical fibers for splicing.

Accordingly, an aspect of the present invention is directed to automating the optical fiber preparation process by performing the steps of stripping, cleaning, and cleaving within a single integrated unit or device. The unit may be designed to allow it to be easily incorporated into a complete automated fusion splicing system. The system may use one or more of these units to prepare the optical fibers, and then the optical fibers may be loaded into a splicer. Once the splicing process in complete, the spliced optical fibers may be automatically or manually moved to a splice sleeve heat oven or an optical fiber recoater. The unit is preferably configured to reduce the operator-required actions for optical fiber preparation to simply loading the optical fiber into the unit and initiating the process.

According to another aspect of the invention, the optical fiber may be translated along a single linear axis (e.g., along a horizontal axis or along the longitudinal axis of the optical fiber) during the strip, clean and cleave preparation process. Such a configuration allows for a more compact and reliable design. However, the fiber may be moved in additional directions. Such an arrangement may also offer some advantages in the ease of disposing of optical fiber coating material generated by the stripping process and of optical fiber scraps generated by the cleaving process. This is because gravity would naturally cause these excess materials to fall to the bottom of the unit for collection and disposal. A vacuum, blower, or other similar device may be used in any configuration of the device to assist in the excess material collection and disposal process.

According to another aspect of the present invention, a still more compact design may be achieved where a plurality of stations are implemented in the unit. For instance, separate stations may exist for each of stripping, cleaning, and cleaving the optical fiber or fibers. These stations may be embodied as physically separate units mounted to a common main body. Also, two or more of these stations may be disposed and aligned within the same plane as the optical fiber as the optical fiber translates. In such a situation, the single axis along which the optical fiber translates may preferably be within the same plane as the at least two other stations. Also, one or more of the stations may themselves translate in order to perform their respective processing on the optical fiber or fibers. Where the unit processes more than one optical fiber in parallel, and where one of the stations is a cleaning station, such as an ultrasonic bath, the optical fibers may simultaneously or otherwise share the same ultrasonic bath while still having their own other dedicated stations for stripping and cleaving. This results in dramatic cost and space savings.

According to yet another aspect of the present invention, the optical fiber preparation unit may further perform processing on a plurality of optical fibers in a serial pipeline processing manner. For instance, the unit may be configured where a first optical is coupled at a first location of the unit, processed, and then removed from a second different location of the unit. These locations may preferably be at the ends of the unit, but the locations may be anywhere on the unit. During or after processing of a first optical fiber, the process may be repeated for additional optical fibers.

Although the invention has been defined using the appended claims, these claims are exemplary and not limiting to the extent that the invention is meant to include one or more elements from the apparatus and methods described herein and in the applications incorporated by reference in any combination or subcombination. Accordingly, there are any numbers of alternative combinations for defining the invention, which incorporate one or more elements from the specification (including the drawings, claims, and applications incorporated by reference) in any combinations or subcombinations.

### BRIEF DESCRIPTION OF THE DRAWINGS

The foregoing summary of the invention, as well as the following detailed description of preferred embodiments, is better understood when read in conjunction with the accompanying drawings, which are included by way of example, and not by way of limitation with regard to the claimed invention. In the accompanying drawings, the same reference number in different drawings refers to the same element.

FIGS. 1A-1C are side views of an exemplary embodiment of an automatic fiber preparation unit having an optical fiber being positioned at first, second, and third stages, respectively, according to aspects of the present invention.

FIG. 1D is a top view of the automatic fiber preparation unit of FIG. 1C.

FIG. 1E is a side view of an alternative exemplary embodiment of an automatic fiber preparation unit according to aspects of the present invention.

FIGS. 1F-1H are side views of another alternative exemplary embodiment of an automatic fiber preparation unit having an optical fiber being positioned at first, second, and third stages, respectively, according to aspects of the present invention.

FIGS. 2A-2C are side views of another exemplary embodiment of an automatic fiber preparation unit having an optical fiber being positioned at first, second, and third stages, respectively, according to aspects of the present invention.

FIG. 3 is a side view of yet another exemplary embodiment of an automatic fiber preparation unit, according to aspects of the present invention.

FIG. 4 is a side view of still another exemplary embodiment of an automatic fiber preparation unit, according to aspects of the present invention.

FIGS. 5A-5C are top, side, and front views, respectively, of another exemplary embodiment of an automatic fiber preparation unit in a home position, according to aspects of the present invention.

FIG. 6 is a top view of the automatic fiber preparation unit of FIGS. 5A-5C in a first position during a stripping step according to aspects of the present invention.

FIG. 7A is a top view, and FIGS. 7B and 7C are side views, of the automatic fiber preparation unit of FIGS. 5A-5C in a second position during a cleaning step, according to aspects of the present invention.

FIG. 8 is a top view of the automatic fiber preparation unit of FIGS. 5A-5C in a third position during a cleaving step with the cleaving devices moved to a cleaving position, according to aspects of the present invention.

FIG. 9 is a top view of the automatic fiber preparation unit similar to FIG. 8 showing the cleaving devices moved to an initial position according to aspects of the present invention.

FIG. 10 is a flow chart illustrating the steps in an exemplary process for automatically preparing an optical fiber for splicing, according to aspects of the present invention.

FIGS. 11A-11C are side views of another embodiment of an automatic fiber preparation unit during first, second, and third steps, respectively, according to aspects of the present invention.

FIGS. 11D and 11E are front views of the automatic fiber preparation unit of FIGS. 11A-11C during the first and second steps, respectively, according to aspects of the present invention.

### DETAILED DESCRIPTION OF PREFERRED EMBODIMENTS

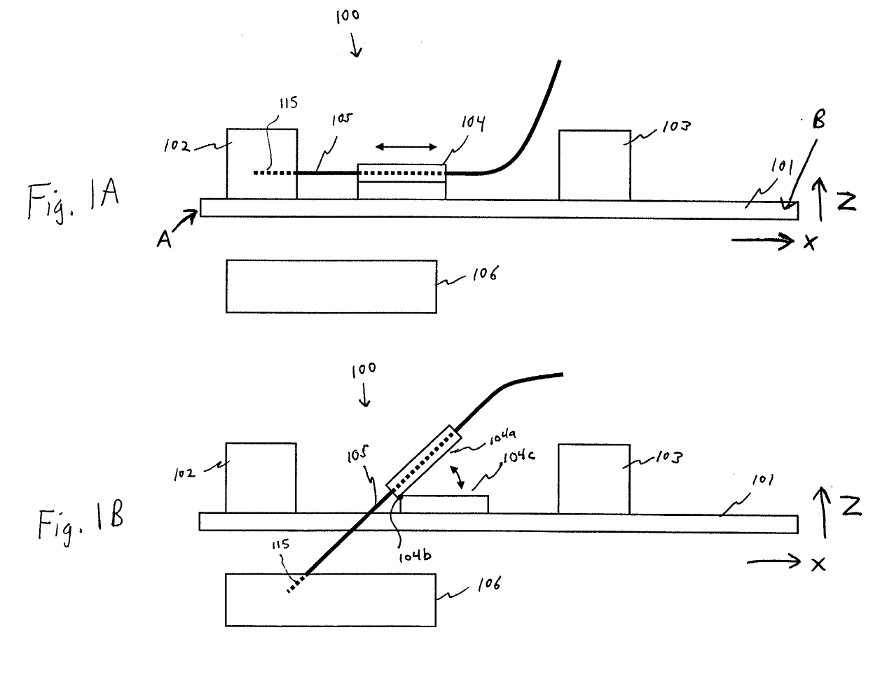

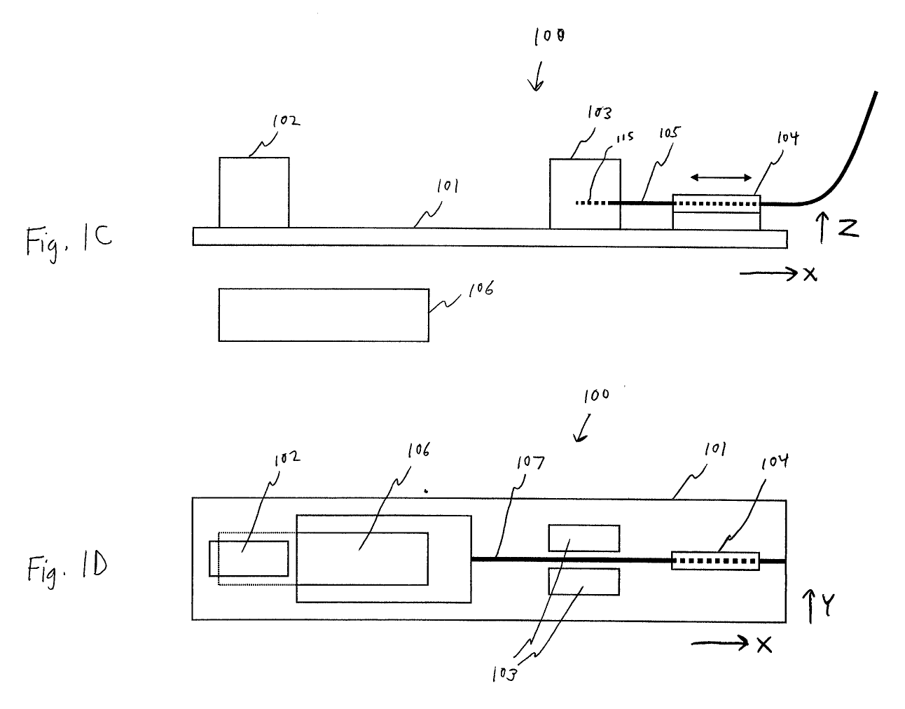

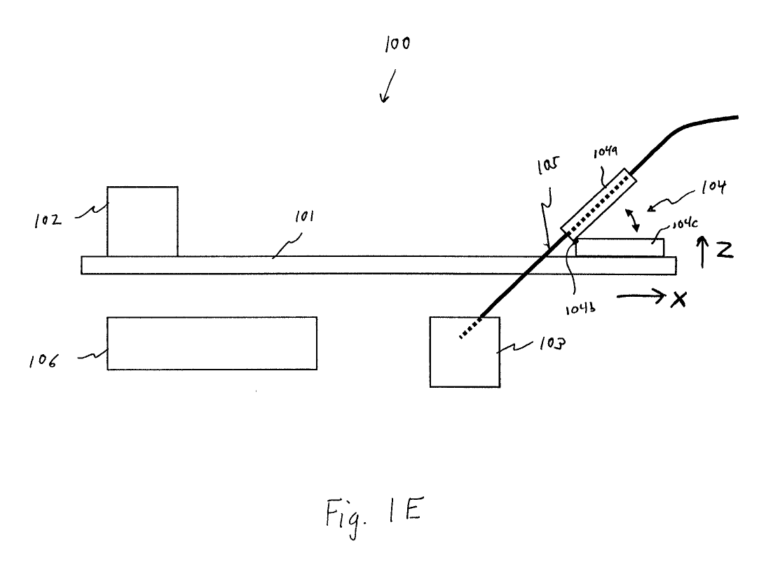

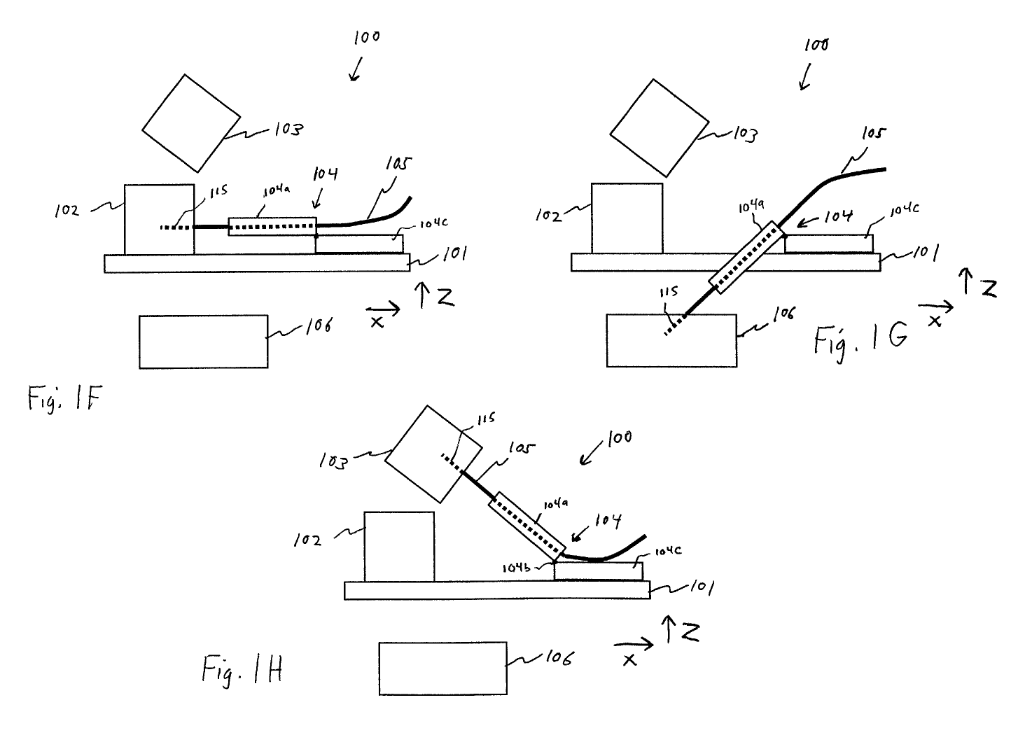

Referring to FIGS. 1A-1C, an exemplary automatic fiber preparation unit 100 (hereafter referred to as “unit 100”) is shown. The unit 100 may include a main body 101 and a carriage 104 moveably coupled with to the main body 101. The term “main body” is a general term that includes within its scope a frame, casing, chassis, housing, body, or other similar structure. In the present example, the carriage 104 may slide along the main body 101 in a single dimension or axis (e.g., along the X-axis in the embodiment shown) in the manner shown by the arrows in FIG. 1A. An optical fiber 105 is coupled to the carriage 104 via a fiber holder or any other desired manner. In a preferred embodiment, the carriage 104 translates along an axis parallel to the longitudinal axis of the optical fiber 105 relative to the main body 101. The term “translate” as used herein refers to a movement other than rotation. Translation does not exclude the possibility of rotation simultaneously with the translation, but rotation alone does not constitute a translation of an object. For instance, pivoting, tilting, and rotating are not considered to be, by themselves, translations. Translation by sliding may be accomplished via a rail system or other known sliding system, and the carriage 104 may be translated in the X-axis relative to the main body 101 by any means such as by a rotary or linear motor(s) and/or pneumatic actuator(s) along with the appropriate drivers. Where a motor is used, it may be any desired motor type, e.g., of the direct-current permanent magnet type or a stepper motor.

The overall motion control for the carriage 104 may be implemented using any control logic technology. For instance, limit switches, relays, programmable logic controllers, embedded microprocessors, and/or programmable logic arrays, as are well known in the art, may be used in any combination or subcombination to control the motion of the carriage 104 and/or other elements of the unit 100.

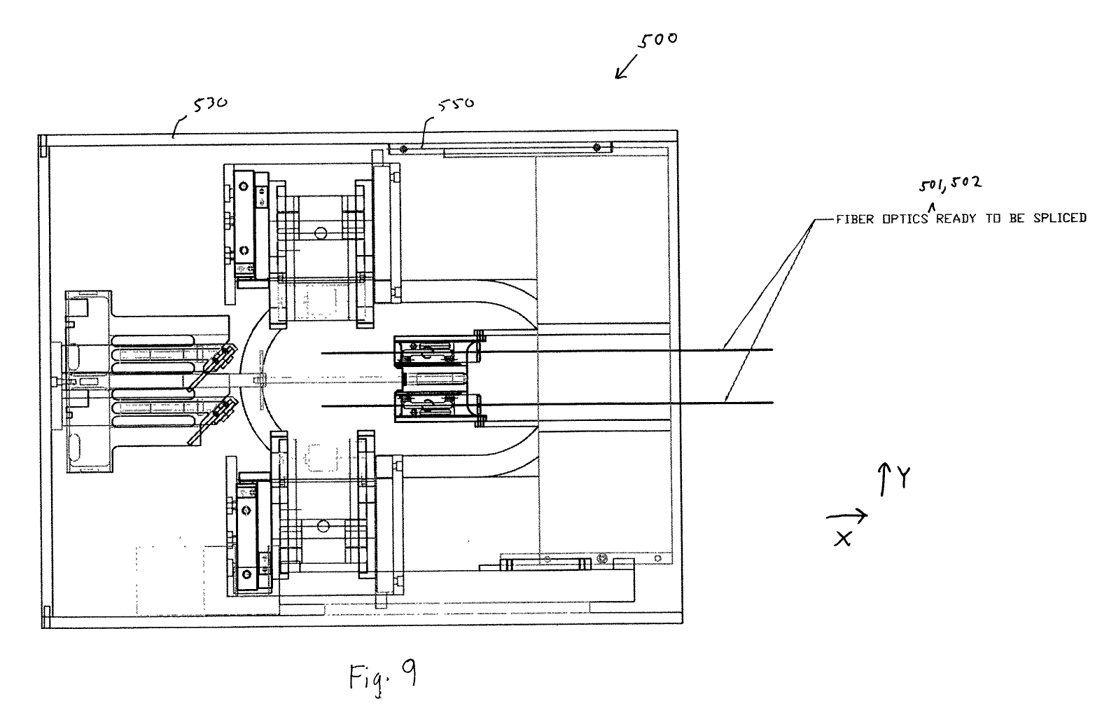

The carriage 104 may be configured to hold an optical fiber 105 directly and/or may be configured to receive an optical fiber holder with an optical fiber 105. The optical fiber 105 is preferably securely held by the carriage 104 to prevent relative movement therebetween. The optical fiber holder may be of any type such as that disclosed in U.S. Pat. No. 5,946,986 to Dodge et al., entitled “Optical Fiber Preparation Unit,” and incorporated herein as to its disclosure of an optical fiber holder, such as FIG. 8 of that patent and its related disclosure.

The unit 100 may further include a plurality of “stations” that may each perform a different function on or to the optical fiber 105. Each station may each be mounted or coupled to the common main body 101 or base. For instance, the unit 100 may include the following stations: a stripping station 102 for stripping the outer protective coating off the optical fiber 105, a cleaning station 106 such as an ultrasonic bath cleaner for cleaning the tip of the stripped optical fiber 105, and a cleaving station 103 for cleaving the optical fiber 105 to produce a reliably cut end face suitable for splicing with. The stripping, cleaning, and cleaving stations 102, 106, 103 may each comprise of individual components and may each function as independent units. Alternatively, the stations 102, 106, 103 may be implemented as interconnected units. For instance, the frames, chassises, and/or housings of the various stations 102, 106, 103 may be physically separate or combined/coupled together. Also, the stations 102, 106, 103 may be powered separately with different power supplies or together with a single power supply.

The stripping station 102 may include any type of optical fiber stripping device such as the HOT STRIPPER™ device marketed by Amherst FiberOptics®, and/or be in accordance with the stripping device disclosed in U.S. Pat. Nos. 5,946,986 or 6,023,996 both to Dodge et al., and both entitled “Optical Fiber Preparation Unit,” and incorporated herein as to their disclosure of an optical fiber stripping device. The stripping station 102 may alternatively use other methods such as by blasting nitrogen onto the optical fiber 105. For mechanical stripping, the optical fiber 105 may be inserted manually by the user and/or aligned with the stripping blades, at the point that stripping should occur. Upon initiation of the automated unit 100, the blades of the stripping device would then automatically close and cut into the coating of the optical fiber 105. The optical fiber 105 would be translated relative to the blades to strip off the coating. This may be done by translating the carriage 104 relative to the stripping device 106, either by moving the carriage 104 or the stripping device 106. The stripping device 106 preferably includes a heating element, not shown, to soften the coating of the fiber 105 for facilitating the stripping process. Further, it is recognized that any desirable actuator and mechanism may be used to control the relative position of the stripping blades.

The cleaning station 106 may include any type of cleaning device such as an ultrasonic cleaner. One such known ultrasonic cleaner is the model EUC 12 Ultrasonic Cleaner, marketed by Ericsson Cables. In a preferred embodiment, the cleaning station 106 includes an elongated or oblong ultrasonic bath, containing alcohol or a similar fluid, into which the optical fiber 105 may be dipped; not shown. An automated shutter, not shown, may be implemented over the surface of the bath in order to control evaporation and to maintain the purity of the fluid. To further maintain the purity of the fluid, a recirculating filter mechanism, not shown, may be utilized to recirculate the fluid through a filter. In a preferred embodiment, the optical fiber 105 is dipped into the bath at an angle such as about 30 to 45 degrees from the horizontal. In an alternative embodiment, the cleaning station 106 may operate by spraying a solvent such as alcohol onto the optical fiber 105.

The cleaving station 103 may include a cleaving device that preferably that produces high quality cleaves in a single step, such as the OFC 2000 or AFC 2000 automated cleaving device currently marketed by Oxford, a British company. However, the cleaving station 103 may cleave optical fibers in multiple steps and may include any type of optical fiber cleaving device.

As shown in FIG. 1A, the carriage 104 may be at a first position relative to the main body 101 so as to locate the free end portion 115 or tip of the optical fiber 105 to be stripped in the stripping station 102. The stripping station 102 preferably includes heating elements around the fiber end 115, as shown in U.S. Pat. Nos. 5,946,986 and 6,023,996, to heat the coating. Opposing blades, not shown, are moved together and into the coating. Stripping may thus occur by relative movement between the fiber and the blades. This may be accomplished by translating the carriage 104 in the positive X-axis direction (i.e., in FIG. 1A, toward the right side of the figure) so as to cause the optical fiber 105 to pull away from the stripping station 102 during the stripping process. Alternatively, the stripping device of the stripping station 102 may translate toward the negative X-axis direction (i.e., in FIG. 1A, toward the left side of the figure) in order to strip the optical fiber 105. Optionally, this could be accomplished by using both techniques.

As shown in FIG. 1B, the carriage 104 may then automatically slide or otherwise translate in the positive X-axis direction to a second position relative to the main body 101 so as to be able to position the tip of the optical fiber 105 in the cleaning station 106. In the exemplary embodiment shown, the carriage 104 may include at least two portions, one of which 104a may pivot or tilt at a pivot point 104b with respect to the other 104c in order to pivot the optical fiber 105 toward the cleaning station 106. In this case, the first portion 104a pivots about an axis 104b parallel to the Y-axis (the Y-axis direction being shown in FIG. 1D) such that the tip 115 of the optical fiber 105 is moved into the cleaning station 106 and the tip of the optical fiber 105 moves in a curve within the X-Z-plane. The pivotal movement may be caused by any desired arrangement such as a pneumatic piston and cylinder. In another embodiment, the entire carriage 104 may tilt, rotate, or pivot with respect to the main body 101 in order to pivot the optical fiber 105 toward the cleaning station 106. To make the unit 100 even more compact and simplified, it is preferable to pivot, rotate, or otherwise dip the tip of the optical fiber 105 into the cleaning station 106 (e.g., into the bath of the cleaning station 106) at an angle rather than vertically, such as at an angle 0 within the range of about 30 to 45 degrees from the horizontal, as shown for example in FIG. 1B. When the tip 115 of the fiber 105 has been cleaned, the top portion 104a may be pivoted by to the horizontal.

As shown in FIG. 1C, the carriage 104 may then automatically slide or otherwise translate along only the X-axis to a third position relative to the main body 101 so as to position the tip 115 of the optical fiber 105 in the area of the cleaving station 103. At this point, the cleaving station 103 may cleave the optical fiber 105 in order to produce a relatively clean free end surface with a perpendicular cut of the optical fiber 105 that is suitable for splicing. The cleaving station 103 may include a unit disposed off of the axis of the fiber 105 and move toward the fiber 105 for affecting the cleaving process. In a preferred embodiment, to make the system compact, the carriage 104 will have translated along only the X-axis for a distance of no more than about 1 foot from beginning to end, i.e., from the position shown in FIG. 1A to the position shown in FIG. 1C.

As shown by the top view of the unit 100 in FIG. 1D, the unit 100 may include one or more rails or slots 107, such as along the X-axis, coupled to the main body 101, along which the carriage 104 may travel. Further, the main body 101 may have an opening through which the optical fiber 105 may be pivoted downward into the cleaning station 106.

The cleaving station 103 may alternatively be disposed at a location spaced from the axis of motion of the carriage 104 and/or away from the main body 101, as shown in FIG. 1E. In such a case, the cleaving station 103 may preferably be oriented at an angle where the carriage 104 may pivot the optical fiber 105 downward (for instance) toward the cleaving station 103 as it does with regard to the cleaning station 106.

As can thus be seen by way of FIGS. 1A-1E, the carriage 104 preferably travels along a single axis (e.g., the X-axis) throughout the stripping, cleaning, and cleaving process. One reason that this is possible is that the stripping station 102, the cleaving station 103, and the optical fiber 105 are all aligned in the same plane. Such a configuration is simple and is relatively immune from error due to misalignment and other inaccuracies. Such a configuration also allows the unit 100 to be integrated while relatively compact. Also, it is preferable that only the steps of stripping, cleaning, and cleaving be performed by the unit 100, but not further steps involved in the splicing process. This allows for the unit 100 to remain compact and portable, and even may allow the unit 100 to be incorporated or integrated into another larger machine that performs further splicing functions.

In an another alternative embodiment as shown by way of FIGS. 1F-1H, the carriage 104 may have a base 104c that does not translate along the main body 101, but instead may remain in place during the processing of the optical fiber 105 while another portion 104a of the carriage 104 pivots up and down (and/or left and right) about a hinge 104b to position the tip 115 of the optical fiber 105 to the various stations 102, 106, and 103. Accordingly, stations 102, 103 and 106 are angularly disposed and spaced equidistant from the hinge point 104b. Such a configuration requires even less complex movement and may therefore be a desirable alternative. Any desirable arrangement, such as a piston cylinder coupled to the two portions 104a and 104b of the carriage 104, may be used to affect the pivotal movement of the pivoting portion 104a. In still another embodiment, a ball joint may be utilized to allow the optical fiber 105 to be maneuvered in any of the three X, Y, and Z dimensions.

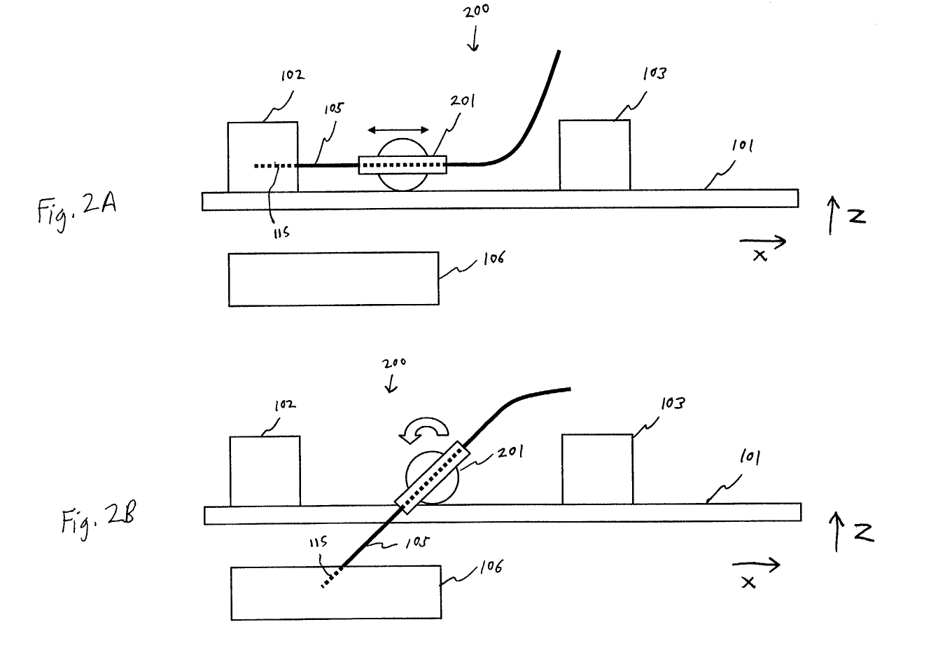

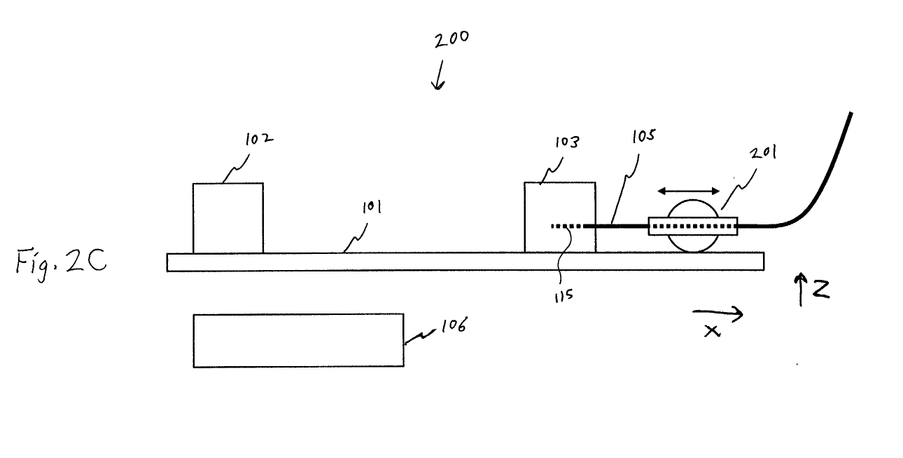

In another alternative embodiment, the carriage 104 may instead be configured as shown in FIGS. 2A-2C. In this embodiment, an automatic fiber preparation unit 200 may have a carriage 201 that translates along a single dimension or axis and also rotates as shown in FIG. 2B to cause the optical fiber 105 to be placed in the cleaning station 106.

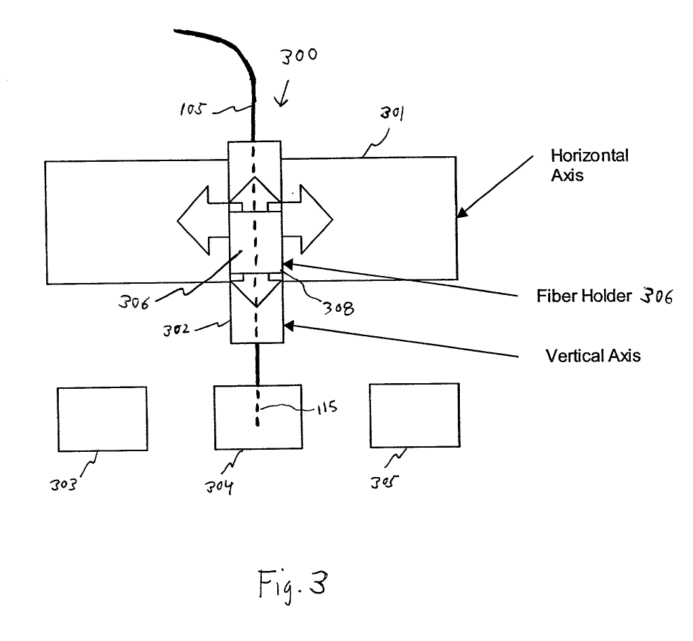

Another exemplary embodiment is shown in FIG. 3, in which an automatic fiber preparation unit 300 translates the optical fiber 105 independently in two orthogonal directions using vertical and horizontal carriages 302, 308 in order to maneuver the optical fiber 105 into various stations 303-305, which may be stripping, cleaning, and cleaving stations, respectively. In this embodiment, the unit 300 may have a main body 301 to which is moveably coupled an optical fiber holder 306 that can translate independently in both the horizontal and vertical directions. Movement may also in this case be provided by motors and/or pneumatic actuators. For instance, there may be provided a motor for controlling horizontal translation of the first carriage 302 relative to the main body 301 and another motor for controlling vertical translation of the second carriage 308 relative to the first carriage 302. The fiber holder 306 may start in a first location above station 303 (e.g., a stripping station), and lower the tip 115 of the optical fiber 105 down into station 303. Then the fiber holder 306 and second carriage 308 may be raised up and translated horizontally by moving the first carriage 302 over above station 304 (e.g., a cleaning station), and subsequently the second carriage 308 can lower the tip 115 of the optical fiber 105 down into station 304. Then the fiber holder 306 and second carriage 308 may be raised up, and translated horizontally over above station 305 (e.g., a cleaving station), and subsequently the second carriage 308 can lower the tip 115 of the optical fiber 105 down into station 305. Then, the fiber holder 306 may again be raised up to remove the optical fiber 105 from station 305.

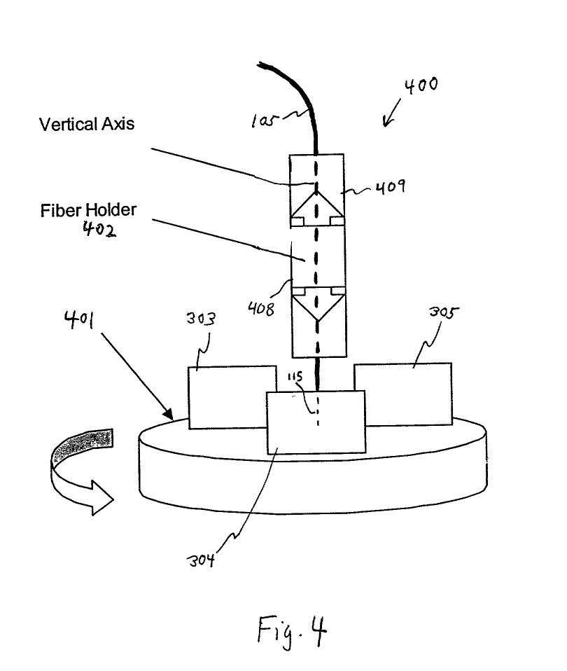

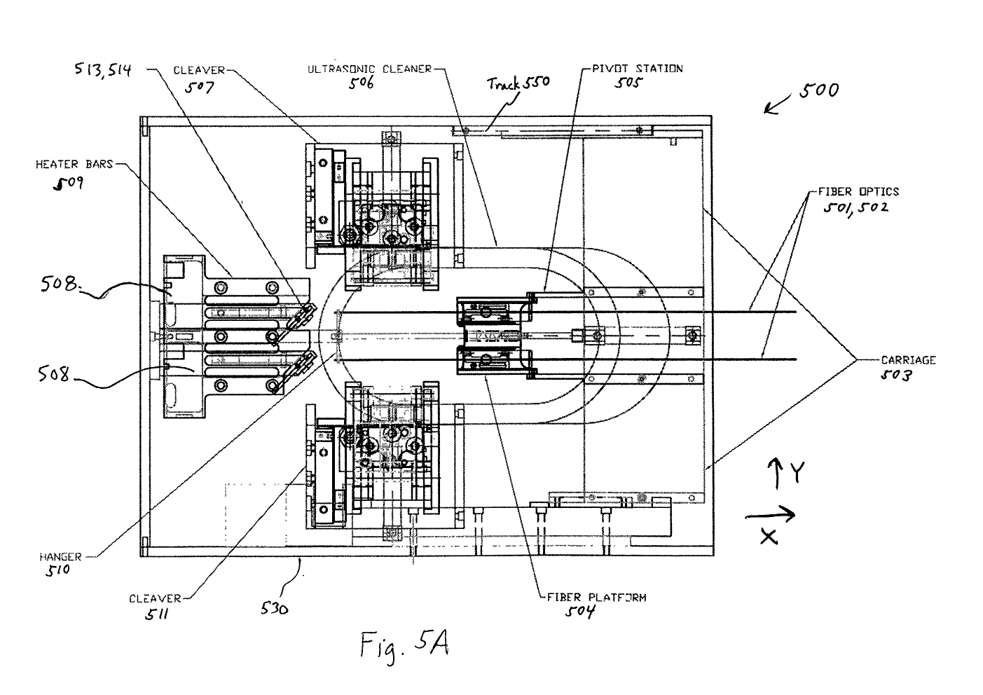

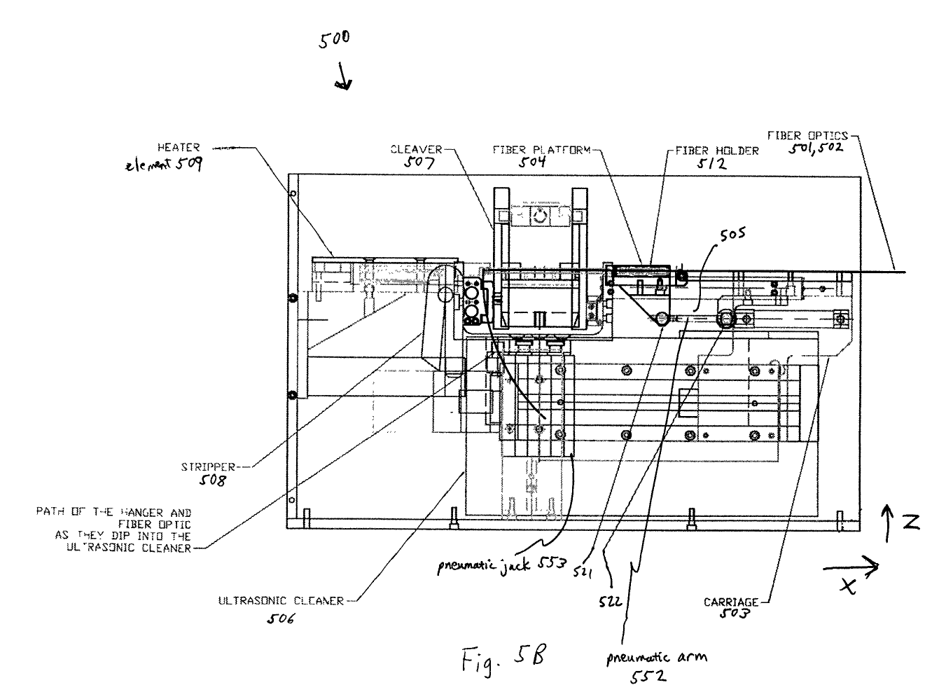

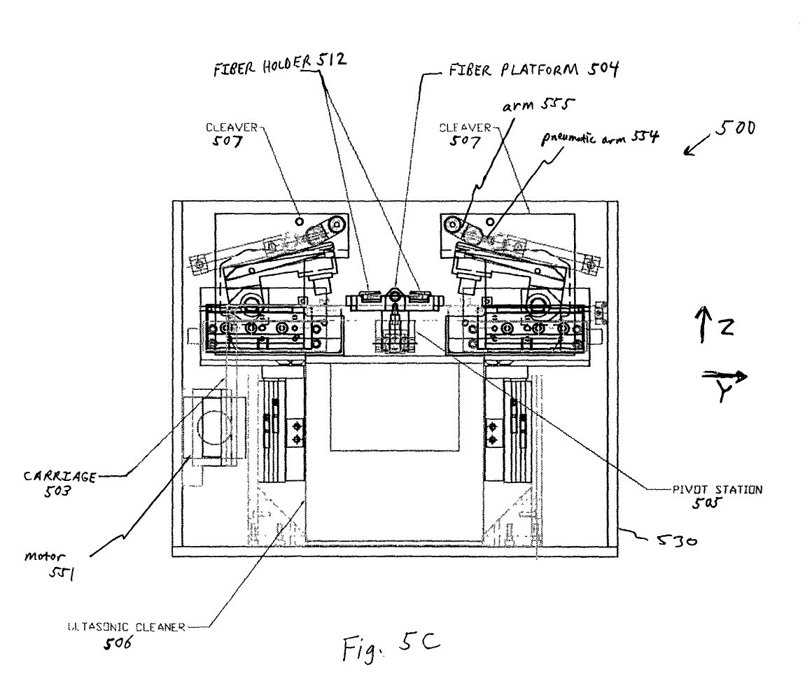

In yet another exemplary embodiment as illustrated in FIG. 4, an automatic fiber preparation unit 400 may include a rotary platform containing the stations 303,304,305. Here, the unit 400 may include an optical fiber holder 402 coupled to a carriage 408 that can translate along a single dimensional or axis (in this example, vertically) relative to a frame 409. A rotatable platform 401, body, or turret may selectively rotate to position a particular one of a plurality of stations such as stations 303-305 under the fiber holder 402. In this way, the tip 115 of the optical fiber 105 maybe automatically lowered into and lifted from any one of the stations 303-305 as desired, such as in the same order described above with regard to FIG. 3.

Referring now to FIGS. 5A-5C, an embodiment of an automatic fiber preparation unit 500 is shown which is similar to that as shown in FIGS. 1A-1D. This unit 500 preferably enables the automatic preparation of two fibers 501, 502 for splicing by the steps of stripping, cleaning, and cleaving. The unit 500 is preferably compact (e.g., about 8 inches in width along the Y-axis by about 12 inches in length along the X-axis by about 10 inches in height along the Z-axis) and incorporates strip, clean, and cleave operations of one or more optical fibers. The unit 500 may include any of the following in any combination or subcombination: one or more optical fiber holders 512 each for holding a respective optical fiber 501, 502; one or more fiber platforms 504 to which the fiber holders 512 are coupled and preferably temporarily affixed and that position the fiber holder 512 with precision; one or more pivot mechanisms 505 such as a pin coupled to the platform 504 in order to allow the platform 504 to pivot relative to a frame or main body 530; one or more moveable or slideable carriages 503 coupled to the mainbody 530 and carrying the platform 504 so as to translate the platform 504 along a single dimension or axis relative to the main body 530; one or more hangars 510 coupled to the optical fibers 501, 502 that support the ends of the optical fibers 501, 502 to maintain them in a straight line, wherein the hangar 510 may be coupled to and supported by the carriage 503 or the platform 504; one or more strippers 508 for stripping the optical fibers 501, 502; one or more heater elements 509 (such as heater bars) as part of the stripping station for heating the optical fibers 501, 502 to allow for easier stripping; one or more ultrasonic cleaners 506 for cleaning the stripped portion of the optical fibers 501, 502; and/or one or more cleavers 507, 511 for cleaving the optical fibers 501, 502. In a preferred embodiment, the strippers 508, the cleavers 507, 511, and the optical fibers 501, 502 are within the same plane. The cleaner 506 may also be in the same common plane. The unit 500 may further include one or more controls and/or signal interfaces (not shown) for allowing a user or another apparatus (such as a computer) to control the operation of the unit 500 based on manual input or a preset program.

In the embodiment shown, multiple optical fibers 501, 502 may be processed in parallel and/or simultaneously by the unit 500. In such a situation, the multiple optical fibers 501, 502 may each have their own associated stripper 508 and their own associated cleaver 511, but may share a single ultrasonic cleaner 506, and more specifically, the same reservoir of the same ultrasonic cleaner 506. Moreover, if desired, the unit 500 may operate on only a single optical fiber at a time.

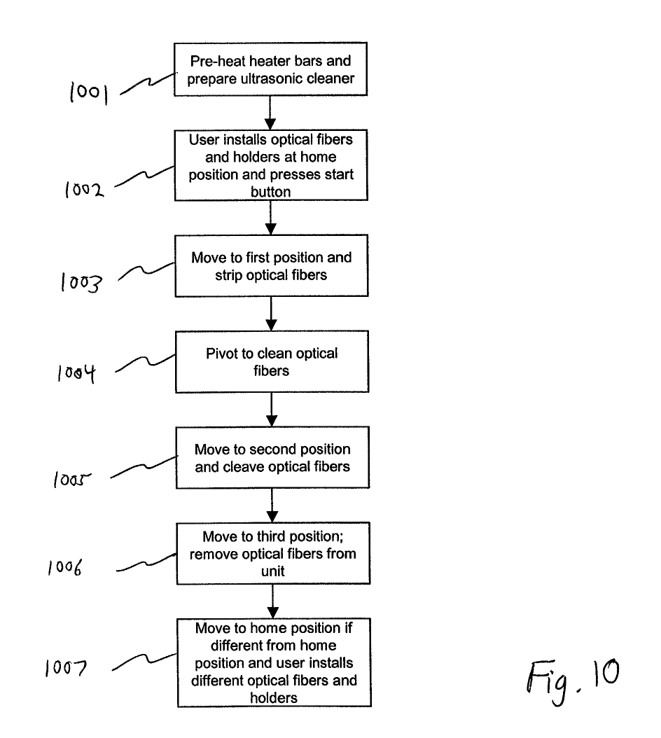

In operation, and referring to FIG. 10 in conjunction with FIGS. 5A-9, the exemplary unit 500 may perform a pre-processing step by bringing the heater element 509 to an appropriate temperature and/or by ensuring that the ultrasonic cleaner is ready for cleaning (step 1001). The unit 500 will preferably at this point be configured such that the carriage 503 and fiber platform 504 are in the “home” position. The home position is such that the optical fibers 501, 501 may be easily loaded in the unit 500. In this example, the home position is where the fiber platform 104 is horizontally disposed and the carriage 503 translate the platform 104 to the right side of the unit 500 such that the optical fibers 501, 502 are not disposed in any of the strippers 508, the ultrasonic cleaner 506, or the cleavers 507, 511. This allows for easy placement of the optical fibers 501, 502 into the unit 500. However, in an alternatively designated home position, the fiber platform 104 may be positioned such that the ends of the optical fibers 501, 502 may alternatively be disposed in their respective strippers 508 such that they are ready for stripping. In one embodiment, the optical fibers 501, 502 are preferably already coupled to their respective fiber holders 512. The fiber holders 512 may be placed in the unit 500 by coupling them to the platform 504. In a preferred embodiment, the fiber holders 512 and the platform 504 include magnets which provide a retentive magnetic attracting force when the fiber holders 512 are placed on the platform 504.

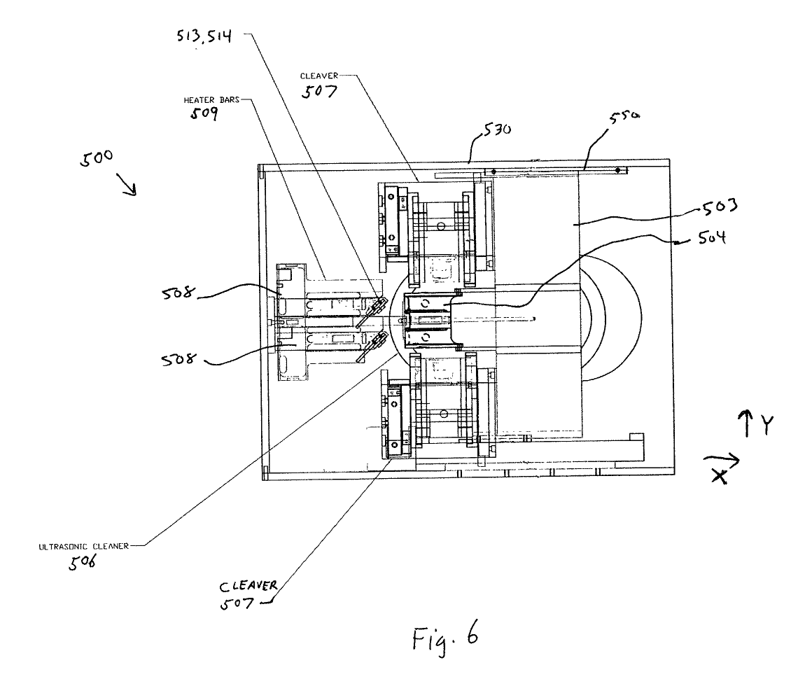

Next, the user may press a start button or otherwise instruct the unit 500 to begin operations (step 1002). This may alternatively be performed by a separate device such as a computer outputting a start signal to the unit 500 or upon the detection of the presence of one or both fiber holders 512 in the platform 504 as detected by any suitable sensor. In response, the carriage 503 may translate the platform 504 to a first position as shown in FIG. 6 (in this case the carriage 503 may translate along the X-axis) where the ends of the fibers 501, 502 are inside the strippers 508 and a portion of the fibers are behind the stripping blades. For example, as seen in FIG. 5a, the carriage 503 may be slideably coupled to the frame 530 by one or more linear tracks 550 and translated in a linear direction. The carriage 503 may be translated by an electric stepper motor 551 driving a worm screw as shown in FIG. 5C or any desired motor, linear actuator, and/or any other powered arrangement. In such a case, the worm screw may be coupled to the carriage 503 causing the carriage 503 to translate in a linear direction in response to the worm screw turning. Such a configuration is useful where it is desirable to vary the length of optical fiber 501, 502 that is stripped by the strippers 508 as needed. This is because the distance traveled by the carriage 503 is easily controlled by controlling the amount the worm screw turns.

The stripping blades 513 may be oriented in any desired direction, and the stripping blades 513 may preferably have handles 514. The handles 514 preferably extend upward or downward in the Z direction and may be disposed at an angle from the axis of the fiber 501, 502. In the exemplary embodiment shown, at least one handle 514 as pivotally mounted relative to the other. A motor, pneumatic actuator, and/or any other desired arrangement may be used to control the movement of handles 514 so that the blades 513 properly engage the coating of the fiber 501, 502. Where a pneumatic actuator is used, one or more valves may be utilized to limit the air pressure applied, thus allowing for more accurate control of the pressure applied by the stripper.

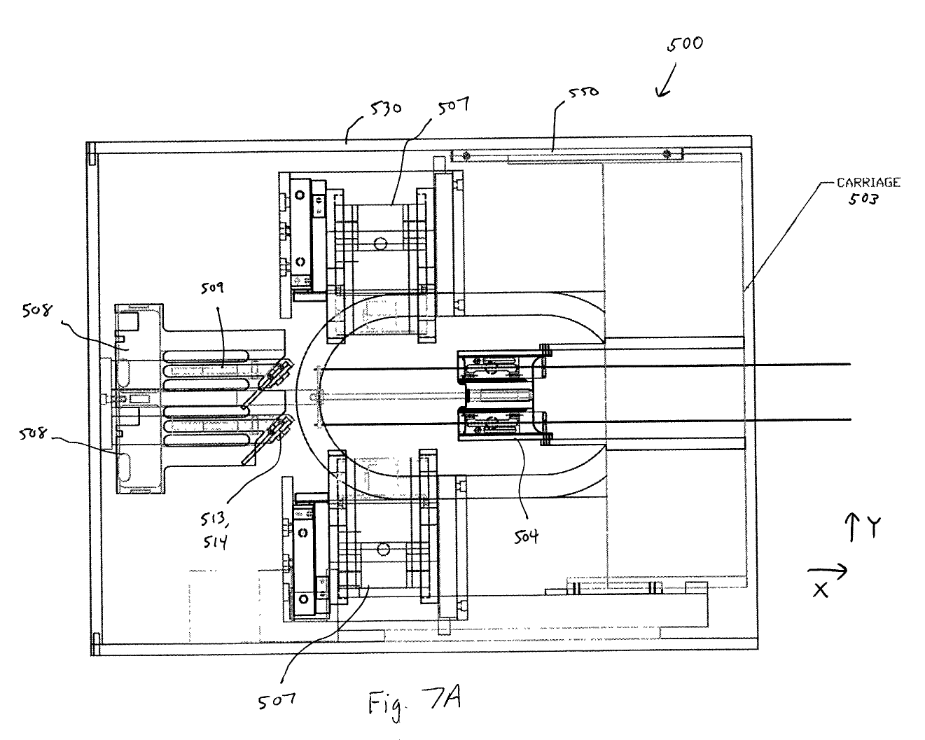

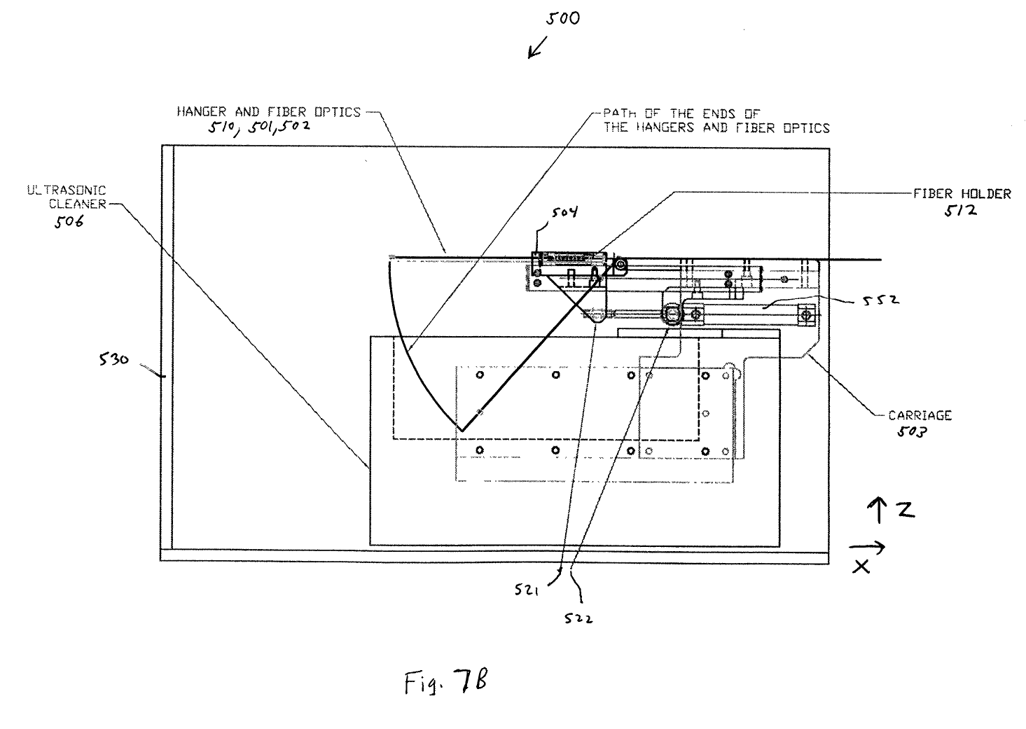

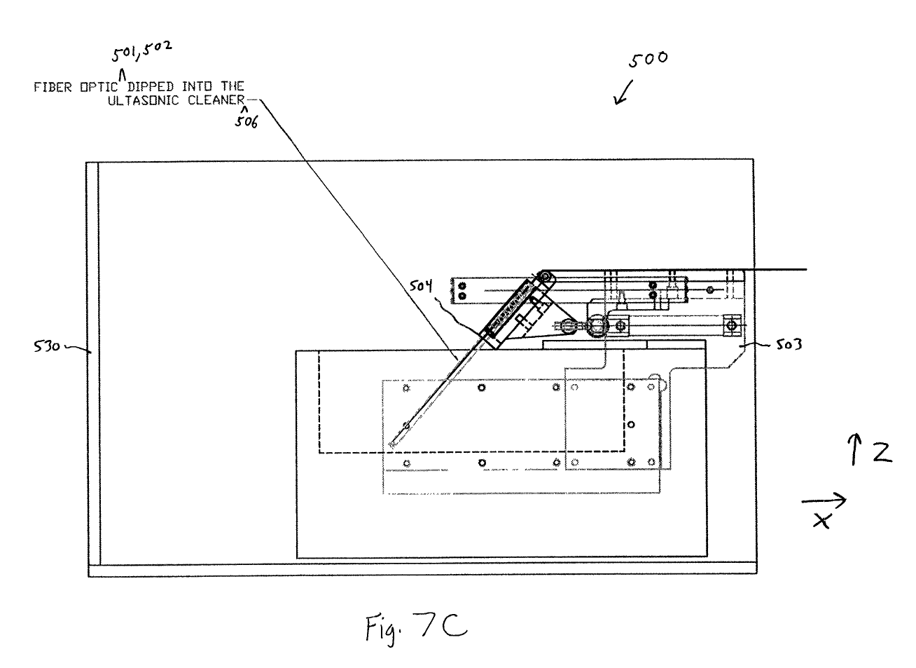

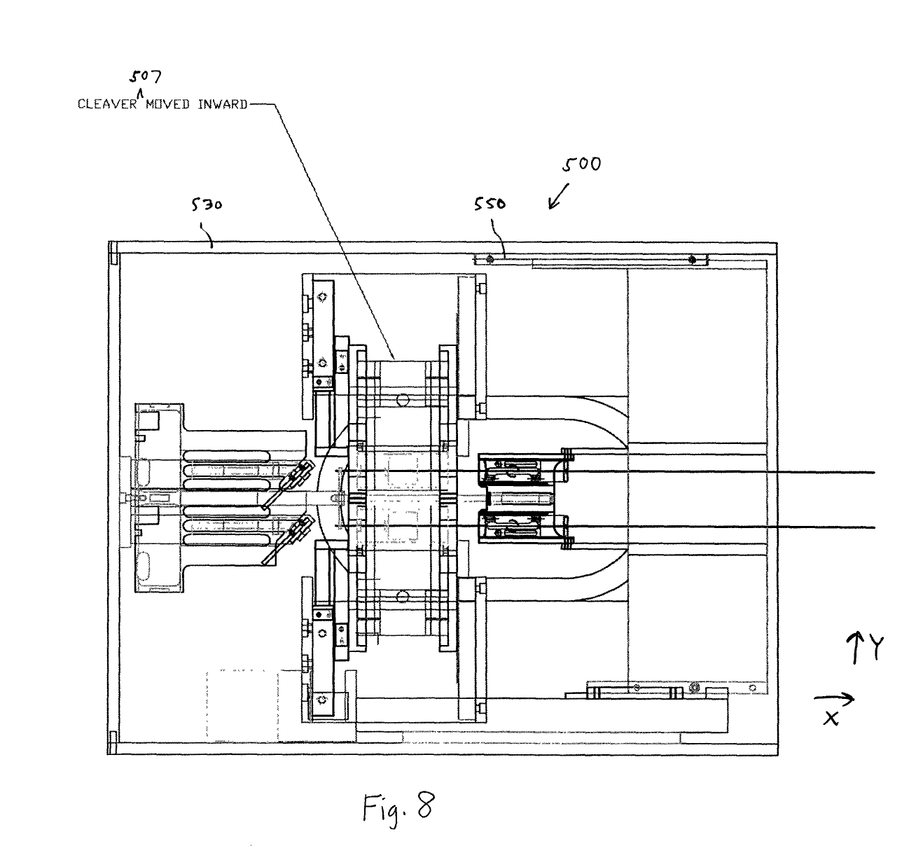

With the blades 513 engaging the coating of the fiber 501, 502, the fiber platform 504 is moved relative to the strippers 508 to increase the distance between the platform 504 and the strippers 508. By this separation, the stripping blades 513 help strip the coating off of the fibers 501, 502. The heater bars 509 facilitate this process. In a preferred arrangement, the separation can be caused by moving the carriage 503 in the positive X direction relative to the frame 530. This moves the platform 504 to a second position, as shown in FIGS. 7A and 7B, which may be the same as the home position of FIGS. 5A-5C. It is recognized that the strippers 508 may be moved in the negative X direction to accomplish this separation.

In this position, the optical fibers 501, 502 are supported and suspended at their free end by the hangar 510. At the pivot station 505, and actuator 552 may now pivot the fiber platform 504 (and thus the fiber holders 512) relative to the carriage 503 and the frame 530 about an axis extending in the Y direction. This dips the optical fibers 501 and/or 502 into the ultrasonic cleaner 506 (step 1004). To accomplish this, a prematic actuator 552 if the piston-cylinder type may be mounted at a first end 521 to the platform 504. The actuator 552 may be hinged or trunnion-mounted to the carriage 503 at its other end 522. In this embodiment, retracting the piston in the actuator 552 causes the platform 504 to pivot downwardly, with the tips of the optical fibers 501, 502 traveling in a curve within a Z-plane. The tips of the optical fibers 501, 502 will thereby be dipped into the ultrasonic cleaner 506. The hangar 510 may also follow with the optical fiber 501, 502 during the pivoting. The optical fibers 501, 502 may remain in the ultrasonic cleaner 506 for a predetermined time to ensure proper cleaning. A timer, which may be implemented manually and/or electronically (e.g., using a microcomputer and/or simple counting circuit), may be used to determine how long the optical fibers 501, 502 remain in the ultrasonic cleaner 506.

As seen most clearly in FIG. 5B, the pivot station 505 may include an extendible arm such as a pneumatic arm 552 including a piston that may extend and contract in order to pivot the platform 504. The pneumatic arm 552 may be hinged or trunnion-mounted to both a fixed point at one end and to a point of the platform 504 at the other end, thereby providing sufficient degrees of freedom to allow the platform 504 to pivot. Thus, when the pneumatic arm 552 contracts (such as is shown in FIG. 7C), the platform 504 pivots downward along the Z-axis, and when the pneumatic arm 552 extends (such as is shown in FIG. 5B), the platform 504 pivots upward along the Z-axis.

The platform 504 is then raised by extending the arm 552. Optionally, the carriage 502 may next translate the platform 504 to a different position along the X-axis in order to position the platform 504 so that the optical fibers 501 and/or 502 may be cleaved (step 1005). At this point, the platform 504 may pivot back up along the Z-axis to its original configuration, the carriage 502 may or may not translate toward the right of the figure in the positive X-axis direction, and the cleavers 507, 511 may be translated inward in the Y direction toward the optical fibers 501 and/or 502 to cleave the optical fibers 501, 502 in parallel, individually, and/or simultaneously. The cleavers 507, 511 may have their blades on the bottom or they may be inverted to have their blades on top of the optical fibers 501, 502.

In one exemplary embodiment, the cleavers 507, 511 may first translate inwardly in the Y-direction to a point below the optical fibers 501, 502, and then upward along the Z-axis so that the optical fibers 501, 502 rest in respective notches or grooves in the cleavers 507, 511. The cleavers may be translated inward and upward by electrical, pneumatic, and/or other arrangements. For instance, the cleavers 507, 511 may each be translated upward by a pneumatic jack 553 (FIG. 5B). The pneumatic jack 553 may include one, two, or more pistons (e.g., multiple pistons to improve the stability of the cleavers 507, 511) that raise each of the cleavers 507, 511 to the desired height. The cleavers 507, 511 may further be engaged to cleave the optical fibers 501, 502 by motor, pneumatic actuator, and/or other arrangements. For instance, a pneumatic arm 554 and a follower arm 555 (both FIG. 5C) may work together as a short pivoting linkage to push the tops of the cleavers 507, 511 downward to cleave the optical fibers 501, 502. In this example, the pneumatic arm 554 extends to cause the follower arm 555 to push downward on the top of the cleavers 507, 511, and retracts to allow the cleavers 507, 511 to spring back upward against the follower arm 555. Where a pneumatic actuator is used, one or more valves may be utilized to limit the air pressure applied, thus allowing for more accurate control of the pressure applied by the cleaver.

Once the optical fibers 501, 502 are cleaved, the carriage 502 may translate toward the right of the figures in the positive X-axis direction, or not at all, to move the platform 504 to a third position (which may be the same as the home position) to allow for easy removal of the fiber holders 512 along with their respective optical fibers 501, 502 (step 1006). At this point, the carriage 502 may then translate the platform 504 back along the X-axis to the home position if necessary so as to be ready to receive another set of fiber holders with optical fibers (step 1007).

Once removed, the fiber holders 512 along with their respective optical fibers 501, 502 that have been stripped, cleaned, and cleaved, may be placed in a separate fusion splicer machine (not shown). This placement may occur manually by the user and/or automatically by a robot. Preferably, the fiber holders 512 are configured to be compatible not only with the unit 500 but also with the fusion splicer machine. In such a case, transferring of the optical fibers 501, 502 between the unit 500 and the splicer machine is quite easy and incurs a low risk of damage to the optical fibers 501, 502 since they need not be removed from the fiber holders 512 prior to splicing.

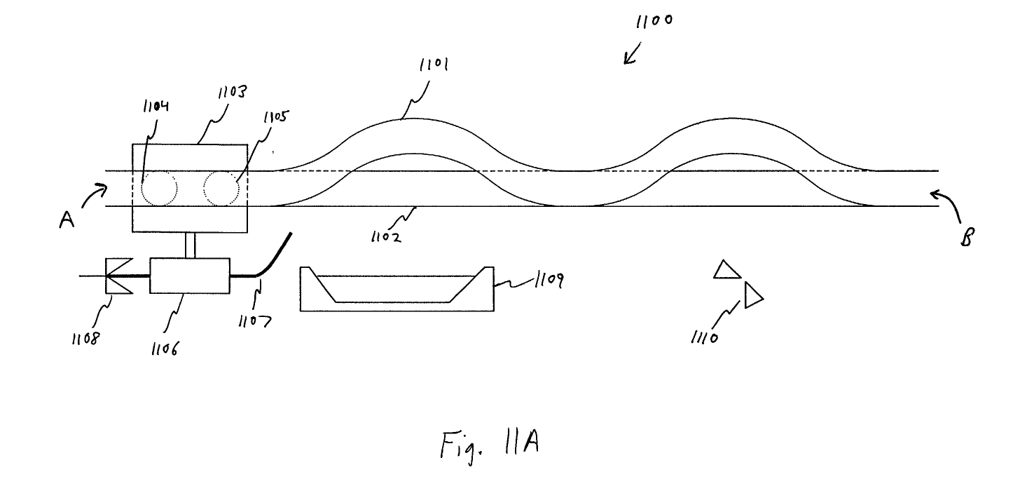

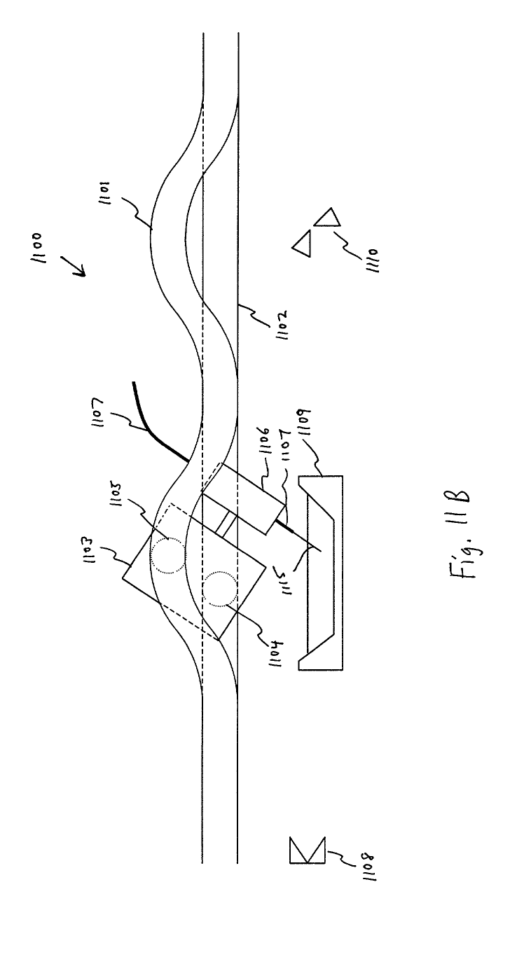

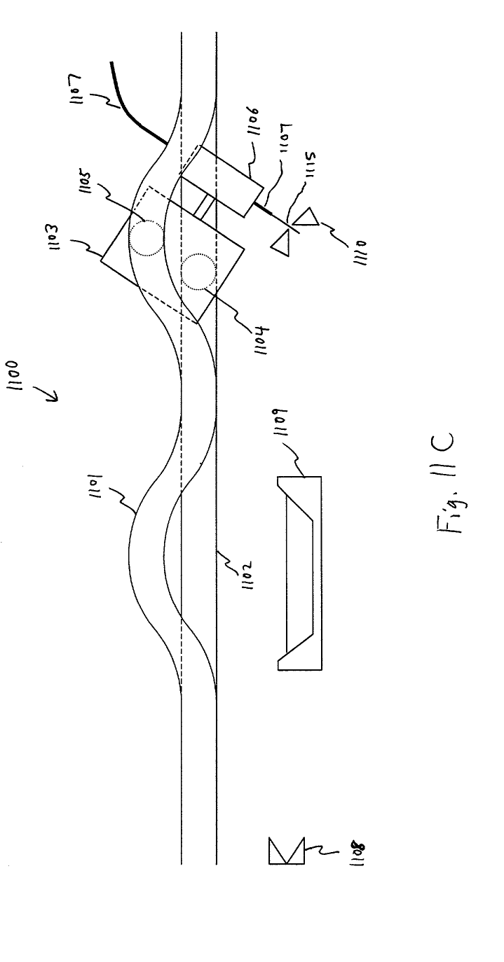

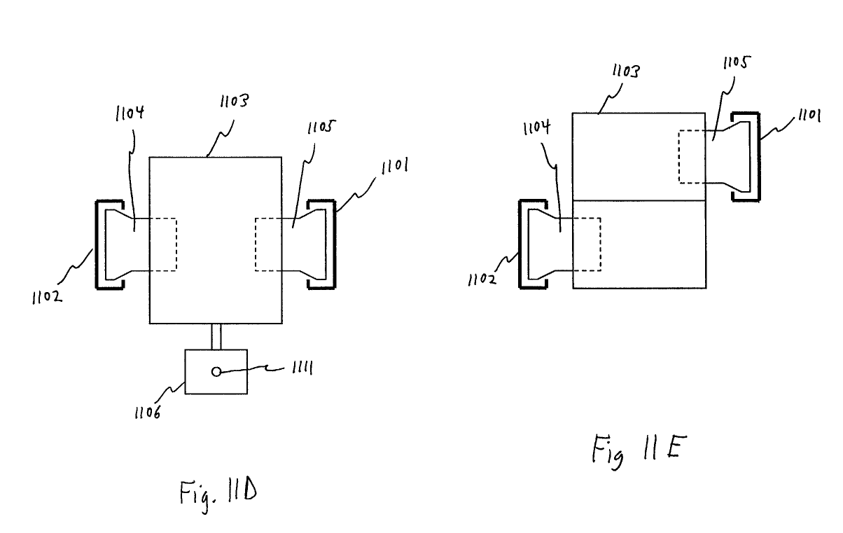

In another exemplary embodiment as shown by way of FIG. 11A., an automatic fiber preparation unit 1100 may include a shuttle-type carriage 1103 having at least two rotatable wheels 1104, 1105 that run along respective tracks 1101, 1102. The wheels 1104, 1105 may be rotatably coupled to the carriage 1103 with axles (not shown). The carriage 1103 may have an extension that receives with an optical fiber holder 1106 as described above. That is, the optical fiber holder 1106 can hold an optical fiber 1107 without slippage. The unit 1100 may further include a variety of stations suitable for preparing the optical fiber 1107 for splicing. In particular, the unit 1100 may preferably include stations similar to those in other embodiments: a stripper 1108, a cleaner 1109, and a cleaver 1110 each disposed at different respective locations of the unit 1100 along the tracks 1101 and 1102.

As shown in the side view of FIG. 11D, the fiber holder 1106 may have a hole 1111 for receiving the optical fiber 1107, such that the optical fiber 1107 may be clamped in the fiber holder 1106 or otherwise fixed therein. The tracks 1101, 1102 may be of any shape that works to allow the wheels 1104, 1105 to travel along them. In the illustrated, the tracks are U-shaped and the wheels 1104, 1105 extend into the space defined by the tracks 1101, 1102. The carriage 1103 may be translated along the tracks 1101, 1102 by any arrangement such as one or more motors and/or pneumatic actuators.

In a preferred arrangement, one track is translating track 1102 and the other track is a platform orientation track 1101. Put another way, the platform orientation track 1101 should have at least one hump. If desired, the wheel 1104 in the straight track 1102 may be driven while the wheel 1105 in the orientation track 1101 may be an idler, i.e., freely rotatable. By driving the wheel 1104 in the straight track, the carriage 1103 will move along the tracks 1101, 1102 from left to right as shown in FIGS. 11A-11C. The idler wheel 1105 will follow in the other track 1101 causing the carriage 1103, and the fiber 1107 or fibers therein, to rotate upwardly and/or downwardly.

The operation of the unit 1100 is better understood via the series of FIGS. 11A-11C. As shown in FIG. 1A, the carriage 1103 and its wheels 1104, 1105 may be positioned at a location on the tracks such that the optical fiber 1107 is caused to be disposed in the stripper 1108. The optical fiber 1107 may then be stripped, either by moving the stripper 1108 and/or the carriage 1103, and the carriage 1103 may translate toward the right for the next operation.

Referring to FIGS. 11B and 11E, as the carriage 1103 translates toward the right of the figure, the idler wheel 1105 is forced to translate up with the track 1101 while the wheel 1104 remains along the straight path defined by the track 1102. The waviness of the track 1101 may be configured to rotate the carriage 1103 just the right amount to cause the optical fiber 1107 to dip into the cleaner 1109. Once the cleaning step has been completed, the carriage 103 may again be moved.

Referring to FIG. 11C, as the carriage 1103 continues toward the right of the figure, the wheel 1105 is now forced back down, possibly in line with the wheel 1104. This causes the tip of the optical fiber 1107 to not rub against the right side of the cleaner 1109. Then, the waviness of the track 1101 again causes the carriage 1103 to rotate to cause the optical fiber 1107 to dip downward, upward, or sideways, etc., so the optical fiber 1107 is within reach of the cleaver 1110. The carriage 1103 may be stopped and the cleaver 1110 may cleave the end of the optical fiber 1107.

Once the optical fiber 1107 has been cleaved, the fiber holder 1106 along with the optical fiber 1107 may be again driven and then removed from the right side of the tracks 1101, 1102 so that the optical fiber 1107 may be spliced by another apparatus. Also, a different fiber holder with another optical fiber may be placed into the left side of the tracks 1101, 1102 and the entire process repeated as for the previous optical fiber 1107. This type of serial pipeline processing saves time, and indeed more than one optical fiber and fiber holder may be on the tracks 1101, 1102 at the same time but in different locations along the tracks 1101, 1102, in order to save even more time. The motor for driving the driver wheel 1104 may be controlled by a timer and, if desired, synchronized with the operation of the stations 1108, 1109, 1110 for efficiency.

While exemplary systems and methods embodying the present invention are shown by way of example, it will be understood, of course, that the invention is not limited to these embodiments. Modifications may be made by those skilled in the art, particularly in light of the foregoing teachings. For example, each of the elements of the aforementioned embodiments may be utilized alone or in combination with elements of the other embodiments. Also, where the terms left, right, up, down, above, and below, are used to describe the relative positions of various elements of automatic fiber preparation units, the invention is not limited thereto and these elements may be located with respect to each other in many variations. For instance, the pivoting or rotation of carriages may be in directions other than in a downward direction, and the carriages may pivot to allow steps to be performed other than cleaning, such as stripping or cleaving. Further, any of the X, Y, and Z axis used to help describe the exemplary embodiments may be interchanged and may be either orthogonal or non-orthogonal to each other. Also, various known cleaving devices, stripping devices, and cleaning devices may be modified in order to be incorporated into the optical fiber preparation units disclosed herein, and one of ordinary skill in the relevant art upon reading the present specification and drawings would understand how to do so with minimal experimentation.

What is claimed is:

1. An apparatus for automatically preparing an optical fiber for splicing, the apparatus comprising:
a stripping station at a first location, said stripping station configured to strip the optical fiber;
a cleaning station at a second location, said cleaning station configured to clean the optical fiber;
a cleaving station at a third location, said cleaving station configured to cleave the optical fiber; and
a fiber transporting device, said fiber transporting device configured to hold an optical fiber and to transport the optical fiber among the stripping station, the cleaning station, and the cleaving station, the fiber transporting device translating along a fixed axis throughout and between the stripping, cleaning, and cleaving process.

2. The apparatus of claim 1, further comprising a platform, said platform pivotally coupled to said fiber transporting device, wherein the platform can pivot the optical fiber toward at least one of the stripping station, the cleaning station, and the cleaving station.

3. The apparatus of claim 1, further comprising a piston cylinder coupled to the platform and the fiber transporting device for affecting pivotal movement therebetween.

4. The apparatus of claim 1, further including a main body to which the stripping station, the cleaning station, and the cleaving station are coupled.

5. The apparatus of claim 4, further including a track coupling the main body with the fiber transporting device, the fiber transporting device being configured to travel relative to the main body along the track.

6. The apparatus of claim 5, wherein said stripping station is in front of said fiber transporting device, said cleaning station is below said fiber transporting device and said cleaving station is laterally disposed from said fiber transporting device.

7. The apparatus of claim 1, wherein the cleaning station includes an ultrasonic bath cleaner.

8. An apparatus for automatically preparing, in parallel, first and second optical fibers for splicing, the apparatus comprising:
a first device configured to perform a certain type of processing on the first optical fiber;
a second device configured to perform the certain type of processing on the second optical fiber; and
a common cleaning reservoir configured to clean both of the first and second optical fibers.

9. The apparatus of claim 8, wherein the certain type of processing includes stripping the respective optical fiber.

10. The apparatus of claim 8, wherein the certain type of processing includes cleaving the respective optical fiber.

11. The apparatus of claim 8, wherein the apparatus is configured such that the first and second optical fibers are cleaned in the cleaning reservoir simultaneously.

12. The apparatus of claim 8, wherein the cleaning reservoir is part of an ultrasonic bath cleaner.

13. A method for preparing optical fibers by a preparation unit for subsequent splicing, the method comprising the steps of:
coupling at a first location of the unit a first optical fiber to a first movable member;
performing at least one of a stripping, cleaning, and cleaving operation on the first optical fiber;
translating the first movable member and the first optical fiber to a removal location of the unit;
removing the first optical fiber from the unit at the removal location;
coupling at the first location a second optical fiber to a second movable member;
performing at least one of a stripping, cleaning, and cleaving operation on the second optical fiber; and
translating the second movable member and the second optical fiber to the removal location, thereby preparing the first and second optical fibers in a pipeline processing manner.

14. The method of claim 13, wherein the performing steps each include performing at least two of a stripping, cleaning, and cleaving operations.

15. The method of claim 14, wherein the performing steps each include performing a stripping, cleaning, and cleaving operation.

16. The method of claim 14, further comprising providing the first and second movable members with wheels and sliding the wheels within tracks to translate and change the orientation of the first and second fibers.

17. An apparatus for automatically preparing an optical fiber for splicing, the apparatus comprising:
a stripping station configured to strip the optical fiber; and
a cleaving station configured to cleave the optical fiber after it has been stripped, wherein the stripping station, the cleaving station, and the optical fiber are all aligned within a common plane.

18. The apparatus of claim 17, further including a carriage configured to translate the optical fiber within the plane.

19. The apparatus of claim 18, further including a cleaning station, wherein the carriage is further configured to permit movement of the optical fiber outside of the plane, thereby manipulating a tip of the optical fiber into the cleaning station.

20. The apparatus of claim 18, further including a cleaning station disposed at a point outside of the plane.

21. The apparatus of claim 17, further including a carriage configured to translate the optical fiber only along a first axis within the plane.

22. The apparatus of claim 21, wherein said cleaving station is movable along a second axis perpendicular to said first axis.

23. The apparatus of claim 27, wherein said apparatus is confined within a cubic volume of no greater than 960 cubic inches.

24. An apparatus for automatically preparing an optical fiber for splicing, the apparatus comprising:
a main body;
a carriage coupled to the optical fiber and configured to translate the optical fiber along a first axis;
a stripping station coupled to the main body and configured to strip the optical fiber; and
a cleaving station coupled to the main body and configured to cleave the optical fiber, wherein the cleaving station is movable to translate along a second axis orthogonal to the first axis, thereby positioning the cleaving station so as to be able to cleave the optical fiber.

25. An apparatus for preparing an optical fiber for splicing comprising:
a main body;
a stripping device coupled to the main body, said stripping device capable of stripping coating off of an optical fiber;
a cleaning device, said cleaning device capable of cleaning the optical fiber after it has been stripped;
a cleaving device coupled to the main body, said cleaving device capable of cleaving the optical fiber after it has been stripped and cleaned; and
a fiber moving device, said fiber moving device including a carriage coupled to the main body for translating movement therebetween and a fiber holding device coupled to the carriage for pivotal movement therebetween.
